(19) United States
(12) Patent Application Publication
(10) Pub. No.: US 2023/0155771 A1
(43) Pub. Date: May 18, 2023

(54) TRANSMISSION AND RECEPTION POINT REPORTING

(71) Applicant: Lenovo (Singapore) PTE. LTD., New Tech Park (SG)

(72) Inventors: Ankit Bhamri, Rödermark (DE); Ali Ramadan Ali, Kraiburg am Inn (DE)

(21) Appl. No.: 17/906,725

(22) PCT Filed: Mar. 17, 2021
(86) PCT No.: PCT/IB2021/052249

§ 371 Date: Sep. 19, 2022

Related U.S. Application Data
(60) Provisional application No. 62/991,695, filed on Mar. 19, 2020.

(51) Int. Cl. H04L 5/00; H04W 24/10; H04W 16/28

(52) U.S. Cl. CPC H04L 5/0051; H04W 24/10; H04W 16/28

(57) ABSTRACT

Apparatuses, methods, and systems are disclosed for transmission and reception point reporting. One method includes receiving information indicating a correspondence between a channel state information reference signal resource, a synchronization signal block resource, or a combination thereof and a transmission and reception point. The method includes reporting a channel measurement report corresponding to the transmission and reception point.

### CROSS-REFERENCE TO RELATED APPLICATIONS

This application claims priority to U.S. Patent Application Ser. No. 62/991,695 entitled “APPARATUSES, METHODS, AND SYSTEMS FOR BEAM MANAGEMENT FOR A HIGH NUMBER OF TRPS FOR FR2 AND BEYOND” and filed on Mar. 19, 2020 for Ankit Bhamri, which is incorporated herein by reference in its entirety.

### FIELD

The subject matter disclosed herein relates generally to wireless communications and more particularly relates to transmission and reception point reporting.

### BACKGROUND

In certain wireless communications networks, multiple transmission and reception points may be in a system. In such networks, reporting may be used for beam management.

### BRIEF SUMMARY

Methods for transmission and reception point reporting are disclosed. Apparatuses and systems also perform the functions of the methods. One embodiment of a method includes receiving information indicating a correspondence between a downlink reference signal resource such as a channel state information reference signal resource, a synchronization signal block resource, uplink reference signals such as a sounding reference signal resource or a combination thereof and a transmission and reception point. In some embodiments, the method includes reporting a channel measurement report corresponding to the transmission and reception point.

One apparatus for transmission and reception point reporting includes a receiver that receives information indicating a correspondence between a downlink reference signal resource such as a channel state information reference signal resource, a synchronization signal block resource, uplink reference signals such as a sounding reference signal resource or a combination thereof and a transmission and reception point. In various embodiments, the apparatus includes a processor that reports a channel measurement report corresponding to the transmission and reception point.

Another embodiment of a method for transmission and reception point reporting includes receiving information indicating quasi-colocation relationships associated with a transmission and reception point. In some embodiments, the method includes configuring transmission configuration indicates states, activating a sub-set of the configured transmission configuration indication states, indicating the transmission configuration indication state from the activated transmission configuration indication states, or a combination thereof based on the quasi-colocation relationship.

Another apparatus for transmission and reception point reporting includes a receiver that receives information indicating quasi-colocation relationships associated with a transmission and reception point. In various embodiments, the apparatus includes a processor that configures transmission configuration indicates states, activates a sub-set of the configured transmission configuration indication state, indicates the transmission configuration indication state from the activated transmission configuration indication states, or a combination thereof based on the quasi-colocation relationship.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for transmission and reception point reporting;

FIG. 2 is a schematic block diagram illustrating one embodiment of an apparatus that may be used for transmission and reception point reporting;

FIG. 3 is a schematic block diagram illustrating one embodiment of an apparatus that may be used for transmission and reception point reporting;

FIG. 4 illustrates one embodiment of a CSI-ResourceConfig resource element;

FIG. 5 is a flow chart diagram illustrating one embodiment of a method for transmission and reception point reporting; and

FIG. 6 is a flow chart diagram illustrating another embodiment of a method for transmission and reception point reporting.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

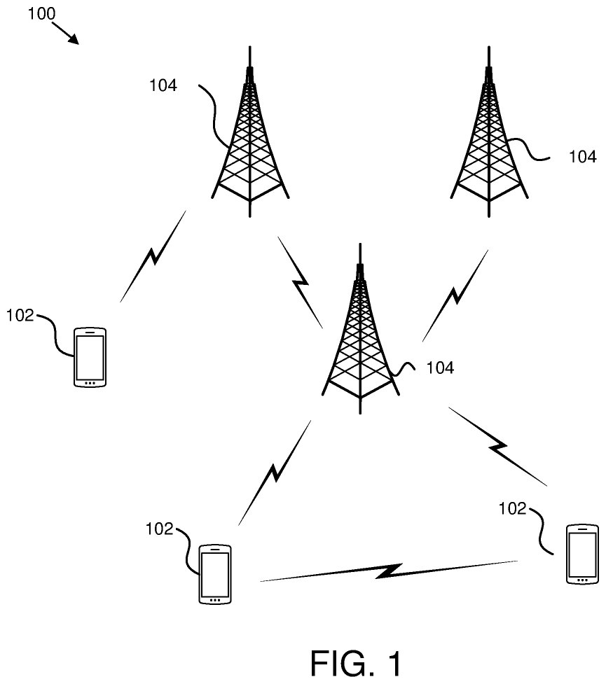

FIG. 1 depicts an embodiment of a wireless communication system 100 for transmission and reception point reporting. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive information indicating a correspondence between a downlink reference signal resource such as channel state information reference signal resource and/or a synchronization signal block resource and/or an uplink reference signal resource such as sounding reference signal resource and a transmission and reception point. In some embodiments, the remote unit 102 may report a channel measurement report corresponding to the transmission and reception point. Accordingly, the remote unit 102 may be used for transmission and reception point reporting.

In certain embodiments, a remote unit 102 may receive information indicating a quasi-colocation relationship associated with a transmission and reception point. In some embodiments, the remote unit 102 may configure transmission configuration indication states, activate a transmission configuration indication state from the configured transmission configuration states and/or indicate a transmission configuration indication state from the activated transmission configuration states based on the quasi-colocation relationship. Accordingly, the remote unit 102 may be used for transmission and reception point reporting.

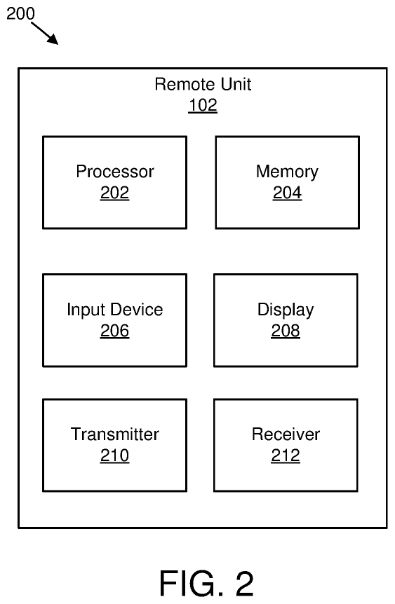

FIG. 2 depicts one embodiment of an apparatus 200 that may be used for transmission and reception point reporting. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In various embodiments, the receiver 212 receives information indicating a correspondence between a channel state information reference signal resource and/or a synchronization signal block resource and a transmission and reception point. In some embodiments, the processor 202 reports a channel measurement report corresponding to the transmission and reception point.

In certain embodiments, the receiver 212 receives information indicating a quasi-colocation relationship associated with a transmission and reception point. In various embodiments, the processor 202 activates a transmission configuration indication state and/or indicates the transmission configuration indication state based on the quasi-colocation relationship.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

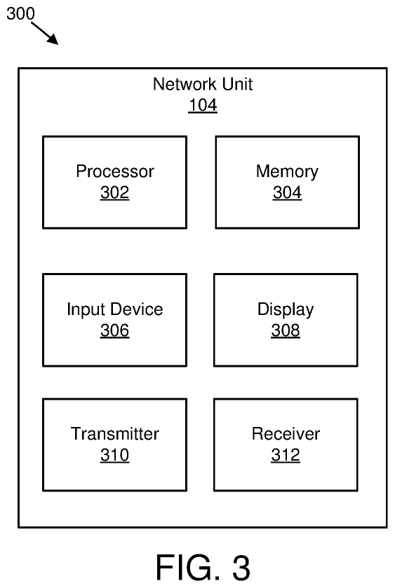

FIG. 3 depicts one embodiment of an apparatus 300 that may be used for transmission and reception point reporting. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, with an increase in a frequency range, beam management may become more crucial in terms of latency and overhead reduction. In some embodiments, a number of beams, a number of transmission and reception points (“TRPs”) at a network, and a number of panels at a UE may increase for frequency range 2 (“FR2”) (e.g., frequency bands from 24.25 GHz to 52.6 GHz) and beyond FR2.

In various embodiments, there may be issues related to CSI reporting overhead if a number of TRPs is high for a high frequency (e.g., FR2 and beyond). In certain embodiments, as frequency increases, beams may become narrower and a greater number of TRPs may be deployed to cover a wider area. In such embodiments, higher overhead for beam management may be necessary. In some embodiments, if using CSI-RS and/or synchronization signal block (“SSB”) for beam management and reporting back channel measurements for multi-TRP configurations, a UE may not know which CSI-RS belongs to which transmission and reception point (“TRP”). In various embodiments, enhancements are made to QCL assumptions and indications (e.g., for multiple TRP configurations).

Described herein are various embodiments for enhancements to multi-TRP configurations with a large number of TRPs for FR2 and beyond (e.g., enhancements to reporting for beam management and for spatial QCL assumptions).

In some embodiments, each CSI-RS resource may be associated with a TRP by adding CORESETPoolIndex to a CSI-ResourceConfig and thereby configuring TRP specific CSI-RS resources to facilitate TRP-based CSI reporting for beam management. In various embodiments, CSI reporting may be enhanced (e.g., for beam management) to send a common and/or single report for each of TRP (e.g., common to all the beams within a TRP), instead of a separate report for each CSI-RS beam.

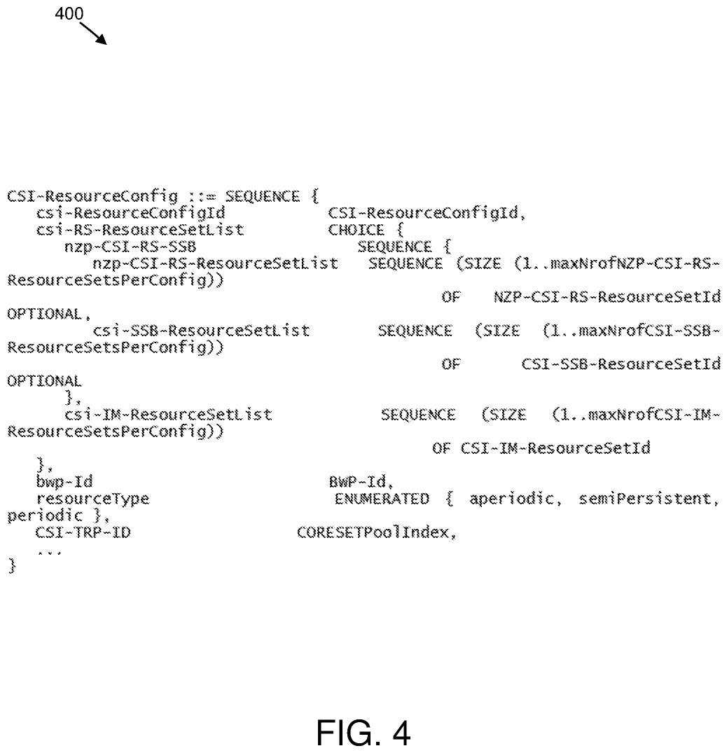

FIG. 4 illustrates one embodiment of a CSI-ResourceConfig resource element 400.

In certain embodiments, a new QCL type (e.g., qcl-typeE) for a TRP-based spatial assumption may be used for a particular TRP identifier (“ID”) (e.g., CORESETPoolIndex) and a target reference signal (“RS”) may be any DL RS (e.g., CSI-RS, SSB, demodulation reference signal (“DM-RS”) for physical downlink control channel (“PDCCH”), DM-RS for physical downlink shared channel (“PDSCH”), DM-RS) or an UL RS (e.g., sounding reference signal (“SRS”), DM-RS for physical uplink shared channel (“PUSCH”) and physical uplink control channel (“PUCCH”)). In some embodiments, if a UE is indicated with a new QCL type, then the UE may be expected to receive a target RS and corresponding channel using the same spatial filter as it used for received the last RS from a TRP with an indicated CORESETPoolIndex in a source.

In various embodiments described herein, there may be a clear association between channel state information reference signal (“CSI-RS”) resources and TRPs. This association may be used for beam management with reduced overhead for reporting. This may be beneficial as a number of TRPs increases with higher frequency in FR2 and beyond (such as beyond 52.6 GHz).

Moreover, in certain embodiments described herein, a coarser indication of QCL assumptions may be enabled in terms of a TRP rather than a specific beam from the TRP. This may enable more QCL assumptions indicated to a UE and/or may enable faster and lower-latency communication with multiple TRPs.

In some embodiments, a UE is configured with CSI-RS resources and each of these resources is associated with a value of a CORESETPoolIndex. In such embodiments, if the UE is triggered with the reception of a CSI-RS on a given resource, then the UE may be expected to receive that CSI-RS from a specific TRP. Upon receiving multiple CSI-RSs corresponding to different beams from the same and different TRPs, the UE performs channel measurement (e.g., reference signal received power (“RSRP”) based on a radio resource control (“RRC”) configured RSRP threshold rsrp-ThresholdCSI-RS). Based on these channel measurements, the UE sends only one CSI report corresponding to each TRP that includes at least an average RSRP across all beams of a corresponding TRP and an associated CORESETPoolIndex value.

In various embodiments, a UE sends only one CSI report corresponding to each TRP that includes at least an average RSRP across all beams of a corresponding TRP, a number of beams that have an RSRP above the average RSRP reported, and an associated CORESETPoolIndex value.

In certain embodiments, a UE sends only one CSI report corresponding to each TRP that includes at least a highest measured RSRP from one of the beams of a corresponding TRP and an associated CORESETPoolIndex value. In some embodiments, a CSI-RS ID is indicated as part of a CSI report instead of a CORESETPoolIndex value. In such embodiments, a UE may infer a value of the CORESETPoolIndex based on a configured association between the CSI-RS ID and the CORESETPoolIndex value.

In various embodiments, a UE sends only one CSI report corresponding to each TRP that includes at least a lowest measured RSRP from one of the beams of a corresponding TRP and an associated CORESETPoolIndex value. In certain embodiments, a CSI-RS ID is indicated as part of a CSI report instead of a CORESETPoolIndex value. In such embodiments, a UE may infer a value of the CORESETPoolIndex based on a configured association between the CSI-RS ID and the CORESETPoolIndex value.

In some embodiments, a UE sends a CSI report with average RSRP values corresponding to only ‘M’ TRPs, where the ‘M’ TRPs are selected based on ‘M’ best average RSRP values across all TRPs. In various embodiments, a UE sends a CSI report with highest RSRP values corresponding to only ‘M’ TRPs, where the ‘M’ TRPs are selected based on highest RSRP values across all TRPs.

In certain embodiments, a UE is configured with CSI-RS resources and each of these resources is associated with a value of a CORESETPoolIndex. In such embodiments, if the UE is triggered by the reception of CSI-RS on a given resource, then the UE may be expected to receive that CSI-RS from a specific TRP. In some embodiments, upon receiving multiple CSI-RSs corresponding to different beams from the same and different TRPs, a UE performs channel measurements (e.g., such as RSRP). Based on the channel measurements, the UE sends only ‘N’ CSI reports corresponding to each TRP that includes at least the best ‘N’ RSRP and corresponding CSI-RS IDs. In such embodiments, the UE may infer a value of a CORESETPoolIndex based on a configured association between the CSI-RS IDs and CORESETPoolIndex values.

In various embodiments, a UE sends only ‘N’ CSI reports corresponding to each of ‘M’ TRPs (e.g., with best channel measurements) that includes at least the best ‘N’ RSRPs and corresponding CSI-RS IDs. In such embodiments, the UE may infer a value of a CORESETPoolIndex based on a configured association between the CSI-RS IDs and CORESETPoolIndex values.

In certain embodiments, a differential RSRP report may be used for each TRP. In such embodiments, a UE sends a CSI report of a beam with the best RSRP measurement and sends a difference between a measured RSRP for each beam and the measured RSRP of the best beam.

In some embodiments, a UE is configured with a quasi-colocation (“QCL”) type (e.g., qcl-typeE) for TRP-based spatial QCL assumptions in which a source is a TRP ID (e.g., such as a CORSETPoolIndex) and a target is a RS ID for either DL or UL. In such embodiments, the configured QCL type may be valid only if more than one CORESETPoolIndex value is associated with configured control resource sets (“CORESETs”) for a UE. In various embodiments, a UE may be configured and activated with transmission configuration indicator (“TCI”) states that indicate a QCL type (e.g., qcl-typeE). Upon indication of the QCL type, the UE may expect to receive a corresponding target RS and associated channel using the same spatial filter that was used to receive the latest RS transmission from one or more beams from a TRP with a source ID.

In certain embodiments, a QCL type may have a source as a combination of a TRP ID and an RS type (e.g., CSI-RS, SSB, SRS). In such embodiments, a UE may expect to receive a corresponding target RS and an associated channel using the same spatial filter that was used to receive the indicated RS transmission from one or more beams from a corresponding TRP with the source ID.

In some embodiments, a single TCI may have more than one QCL type (e.g., qcl-typeE) assumption. In such embodiments, if more than one source TRP ID (e.g., multiple CORESETPoolIndex values) may indicate that a UE should expect a target RS and associated channel transmission from multiple TRPs.

In various embodiments, if a UE is capable of beam correspondence, then an indicated TCI state may be used for UL transmission (e.g., the UE may use the same spatial filter for transmission of UL to a given TRP that was used to receive the DL from the same TRP). The UE may use this correspondence to report CSI on a transmit (“TX”) beam corresponding to a receive (“RX”) beam associated with CSI-RS with the best RSRP measurement.

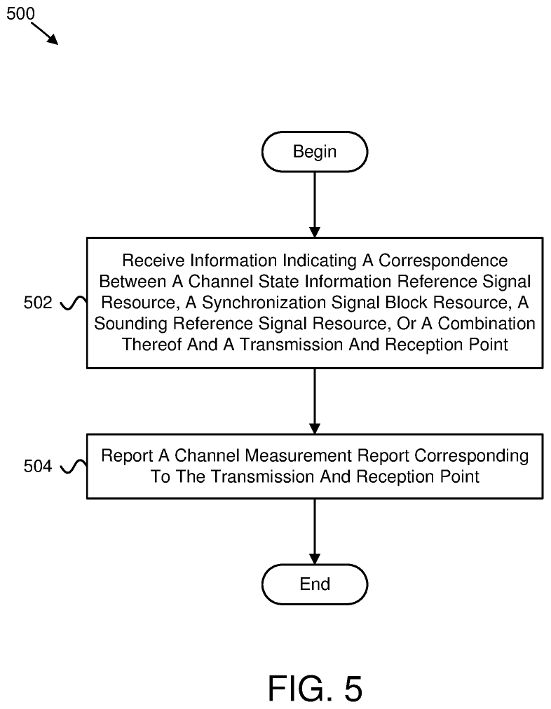

FIG. 5 is a flow chart diagram illustrating one embodiment of a method 500 for transmission and reception point reporting. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502 information indicating a correspondence between a channel state information reference signal resource, a synchronization signal block resource, a sounding reference signal resource, or a combination thereof and a transmission and reception point. In some embodiments, the method 500 includes reporting 504 a channel measurement report corresponding to the transmission and reception point.

In certain embodiments, the information is transmitted using radio resource control signaling. In some embodiments, the information comprises a CSI-ResourceConfig. In various embodiments, the information indicating the correspondence between the channel state information reference signal resource, the synchronization signal block resource, a sounding reference signal resource, or the combination thereof and the transmission and reception point comprises an index. In one embodiment, an identifier is associated with the transmission and reception point. In certain embodiments, the channel measurement report is associated with the identifier.

In some embodiments, the identifier corresponds to a CORESETPoolIndex. In various embodiments, the channel measurement report comprises a highest referenced signal received power for beams transmitted from the transmission and reception point on associated channel state information reference signal resources. In one embodiment, the channel measurement report comprises a set of ‘N’ highest referenced signal received powers for beams transmitted from the transmission and reception point on associated channel state information reference signal resources.

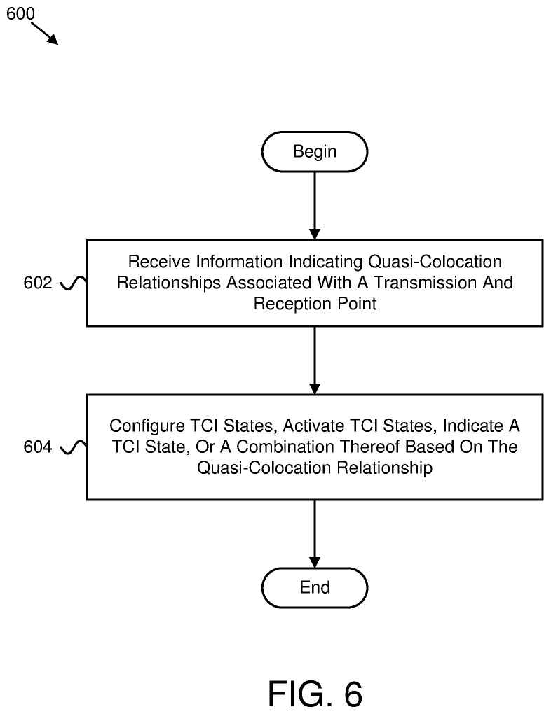

FIG. 6 is a flow chart diagram illustrating another embodiment of a method 600 for transmission and reception point reporting. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602 information indicating a quasi-colocation relationship associated with a transmission and reception point. In some embodiments, the method 600 includes configuring 604 transmission configuration indication states, activating transmission configuration indication states from the configured transmission configuration indication states, indicating a transmission configuration indication state from the activated transmission configuration indication states, or a combination thereof based on the quasi-colocation relationship.

In certain embodiments, the information comprises a radio resource configuration. In some embodiments, the information indicates an identifier corresponding to the transmission and reception point. In various embodiments, the identifier is a downlink reference signal identifier associated with a physical downlink control channel transmission, a physical downlink shared channel transmission, a channel state information reference signal, a synchronization signal block, or a combination thereof. In one embodiment, the identifier is an uplink reference signal identifier associated with a physical uplink control channel transmission, a physical uplink shared channel transmission, a sounding reference signal, or a combination thereof.

In certain embodiments, the identifier corresponds to a CORESETPoolIndex. In some embodiments, the quasi-colocation relationship is indicated with a reference signal associated with the transmission and reception point. In various embodiments, radio resource control signaling, a medium access control control element, downlink control information, or some combination thereof is used for configuring the transmission configuration indication state, activating the transmission configuration indication state, indicating the transmission configuration indication state, or the combination thereof.

In one embodiment, a source for the transmission and reception point-based quasi-colocation relationship comprises a transmission and reception point identifier and a downlink reference signal type. In certain embodiments, the method 600 further comprises receiving a target reference signal and an associated channel corresponding to the transmission and reception point-based quasi-colocation relationship using the same spatial filter used to receive a reference signal transmission from at least one beam from a transmission and reception point corresponding to the transmission and reception point identifier. In some embodiments, a source for the transmission and reception point-based quasi-colocation relationship comprises a transmission and reception point identifier.

In various embodiments, the method 600 further comprises receiving a target reference signal and an associated channel corresponding to the transmission and reception point-based quasi-colocation relationship using the same spatial filter used to receive a previous reference signal transmission from at least one beam from a transmission and reception point corresponding to the transmission and reception point identifier. In one embodiment, a single transmission and reception point comprises a plurality transmission and reception point-based quasi-colocation relationships.

In certain embodiments, a plurality of transmission and reception point identifiers indicates an expectation of a target reference signal and associated channel transmission from a plurality of transmission and reception points. In some embodiments, in response to a user equipment being capable of beam correspondence, the transmission and reception point-based quasi-colocation relationship is used for uplink beam management. In various embodiments, the method 600 further comprises using the same spatial filter for transmissions and receptions for a single transmission and reception point.

In one embodiment, a method comprises: receiving information indicating a correspondence between a channel state information reference signal resource, a synchronization signal block resource, or a combination thereof and a transmission and reception point; and reporting a channel measurement report corresponding to the transmission and reception point.

In certain embodiments, the information is transmitted using radio resource control signaling.

In some embodiments, the information comprises a CSI-ResourceConfig.

In various embodiments, the information indicating the correspondence between the channel state information reference signal resource, the synchronization signal block resource, or the combination thereof and the transmission and reception point comprises an index.

In one embodiment, an identifier is associated with the transmission and reception point.

In certain embodiments, the channel measurement report is associated with the identifier.

In some embodiments, the identifier corresponds to a CORESETPoolIndex.

In various embodiments, the channel measurement report comprises a highest referenced signal received power for beams transmitted from the transmission and reception point on associated channel state information reference signal resources.

In one embodiment, the channel measurement report comprises a set of ‘N’ highest referenced signal received powers for beams transmitted from the transmission and reception point on associated channel state information reference signal resources.

In one embodiment, an apparatus comprises: a receiver that receives information indicating a correspondence between a channel state information reference signal resource, a synchronization signal block resource, or a combination thereof and a transmission and reception point; and a processor that reports a channel measurement report corresponding to the transmission and reception point.

In certain embodiments, the information is transmitted using radio resource control signaling.

In some embodiments, the information comprises a CSI-ResourceConfig.

In various embodiments, the information indicating the correspondence between the channel state information reference signal resource, the synchronization signal block resource, or the combination thereof and the transmission and reception point comprises an index.

In one embodiment, an identifier is associated with the transmission and reception point.

In certain embodiments, the channel measurement report is associated with the identifier.

In some embodiments, the identifier corresponds to a CORESETPoolIndex.

In various embodiments, the channel measurement report comprises a highest referenced signal received power for beams transmitted from the transmission and reception point on associated channel state information reference signal resources.

In one embodiment, the channel measurement report comprises a set of ‘N’ highest referenced signal received powers for beams transmitted from the transmission and reception point on associated channel state information reference signal resources.

In one embodiment, a method comprises: receiving information indicating a quasi-colocation relationship associated with a transmission and reception point; and configuring transmission configuration indication state, activating the transmission configuration indication state, indicating the transmission configuration indication state, or a combination thereof based on the quasi-colocation relationship.

In certain embodiments, the information comprises a radio resource configuration.

In some embodiments, the information indicates an identifier corresponding to the transmission and reception point.

In various embodiments, the identifier is a downlink reference signal identifier associated with a physical downlink control channel transmission, a physical downlink shared channel transmission, a channel state information reference signal, a synchronization signal block, or a combination thereof.

In one embodiment, the identifier is an uplink reference signal identifier associated with a physical uplink control channel transmission, a physical uplink shared channel transmission, a sounding reference signal, or a combination thereof.

In certain embodiments, the identifier corresponds to a CORESETPoolIndex.

In some embodiments, the quasi-colocation relationship is indicated with a reference signal associated with the transmission and reception point.

In various embodiments, radio resource control signaling, a medium access control control element, downlink control information, or some combination thereof is used for configuring the transmission configuration indication state, activating the transmission configuration indication state, indicating the transmission configuration indication state, or the combination thereof.

In one embodiment, a source for the transmission and reception point-based quasi-colocation relationship comprises a transmission and reception point identifier and a downlink reference signal type.

In certain embodiments, the method further comprises receiving a target reference signal and an associated channel corresponding to the transmission and reception point-based quasi-colocation relationship using the same spatial filter used to receive a reference signal transmission from at least one beam from a transmission and reception point corresponding to the transmission and reception point identifier.

In some embodiments, a source for the transmission and reception point-based quasi-colocation relationship comprises a transmission and reception point identifier.

In various embodiments, the method further comprises receiving a target reference signal and an associated channel corresponding to the transmission and reception point-based quasi-colocation relationship using the same spatial filter used to receive a previous reference signal transmission from at least one beam from a transmission and reception point corresponding to the transmission and reception point identifier.

In one embodiment, a single transmission and reception point comprises a plurality transmission and reception point-based quasi-colocation relationships.

In certain embodiments, a plurality of transmission and reception point identifiers indicates an expectation of a target reference signal and associated channel transmission from a plurality of transmission and reception points.

In some embodiments, in response to a user equipment being capable of beam correspondence, the transmission and reception point-based quasi-colocation relationship is used for uplink beam management.

In various embodiments, the method further comprises using the same spatial filter for transmissions and receptions for a single transmission and reception point.

In one embodiment, an apparatus comprises: a receiver that receives information indicating a quasi-colocation relationship associated with a transmission and reception point; and a processor that configures transmission configuration indication state, activates the transmission configuration indication state, indicating the transmission configuration indication state, or a combination thereof based on the quasi-colocation relationship.

In certain embodiments, the information comprises a radio resource configuration.

In some embodiments, the information indicates an identifier corresponding to the transmission and reception point.

In various embodiments, the identifier is a downlink reference signal identifier associated with a physical downlink control channel transmission, a physical downlink shared channel transmission, a channel state information reference signal, a synchronization signal block, or a combination thereof.

In one embodiment, the identifier is an uplink reference signal identifier associated with a physical uplink control channel transmission, a physical uplink shared channel transmission, a sounding reference signal, or a combination thereof.

In certain embodiments, the identifier corresponds to a CORESETPoolIndex.

In some embodiments, the quasi-colocation relationship is indicated with a reference signal associated with the transmission and reception point.

In various embodiments, radio resource control signaling, a medium access control control element, downlink control information, or some combination thereof is used for configuring the transmission configuration indication state, activating the transmission configuration indication state, indicating the transmission configuration indication state, or the combination thereof.

In one embodiment, a source for the transmission and reception point-based quasi-colocation relationship comprises a transmission and reception point identifier and a downlink reference signal type.

In certain embodiments, the receiver receives a target reference signal and an associated channel corresponding to the transmission and reception point-based quasi-colocation relationship using the same spatial filter used to receive a reference signal transmission from at least one beam from a transmission and reception point corresponding to the transmission and reception point identifier.

In some embodiments, a source for the transmission and reception point-based quasi-colocation relationship comprises a transmission and reception point identifier.

In various embodiments, the receiver receives a target reference signal and an associated channel corresponding to the transmission and reception point-based quasi-colocation relationship using the same spatial filter used to receive a previous reference signal transmission from at least one beam from a transmission and reception point corresponding to the transmission and reception point identifier.

In one embodiment, a single transmission and reception point comprises a plurality transmission and reception point-based quasi-colocation relationships.

In certain embodiments, a plurality of transmission and reception point identifiers indicates an expectation of a target reference signal and associated channel transmission from a plurality of transmission and reception points.

In some embodiments, in response to a user equipment being capable of beam correspondence, the transmission and reception point-based quasi-colocation relationship is used for uplink beam management.

In various embodiments, the processor uses the same spatial filter for transmissions and receptions for a single transmission and reception point.

Embodiments may be practiced in other specific forms. The described II) embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving information indicating a correspondence between a channel state information reference signal resource, a synchronization signal block resource, or a combination thereof and a transmission and reception point; and
reporting a channel measurement report corresponding to the transmission and reception point.

2. The method of claim 1, wherein an identifier is associated with the transmission and reception point.

3. The method of claim 2, wherein the channel state information reference signal resource, a synchronization signal block resource, or a combination thereof and corresponding channel measurement report are associated with the identifier.

4. The method of claim 2, wherein the identifier corresponds to a CORESETPoolIndex.

5. The method of claim 1, wherein the channel measurement report comprises a highest referenced signal received power for beams transmitted from the transmission and reception point on associated channel state information reference signal resources.

6. The method of claim 1, wherein the channel measurement report comprises a set of ‘N’ highest referenced signal received powers for beams transmitted from the transmission and reception point on associated channel state information reference signal resources.

7. An apparatus comprising:
a receiver that receives information indicating a correspondence between a channel state information reference signal resource, a synchronization signal block resource, or a combination thereof and a transmission and reception point; and
a processor that reports a channel measurement report corresponding to the transmission and reception point.

8. The apparatus of claim 7, wherein an identifier is associated with the transmission and reception point.

9. The apparatus of claim 8, wherein the channel state information reference signal resource, a synchronization signal block resource, or a combination thereof and corresponding channel measurement report are associated with the identifier.

10. The apparatus of claim 8, wherein the identifier corresponds to a CORESETPoolIndex.

11. The apparatus of claim 7, wherein the channel measurement report comprises a highest referenced signal received power for beams transmitted from the transmission and reception point on associated channel state information reference signal resources.

12. The apparatus of claim 7, wherein the channel measurement report comprises a set of ‘N’ highest referenced signal received powers for beams transmitted from the transmission and reception point on associated channel state information reference signal resources.

13. (canceled)

14. (canceled)

15. (canceled)

16. (canceled)

17. An apparatus comprising:
a receiver that receives information indicating a quasi-colocation relationship associated with a transmission and reception point; and
a processor that activates a transmission configuration indication state, indicates the transmission configuration indication state, or a combination thereof based on the quasi-colocation relationship.

18. The apparatus of claim 17, wherein the quasi-colocation relationship is indicated with a reference signal associated with the transmission and reception point.

19. The apparatus of claim 17, wherein a source for the transmission and reception point-based quasi-colocation relationship comprises a transmission and reception point identifier and a downlink reference signal type.

20. The apparatus of claim 19, wherein the receiver receives a target reference signal and an associated channel corresponding to the transmission and reception point-based quasi-colocation relationship using the same spatial filter used to receive a reference signal transmission from at least one beam from a transmission and reception point corresponding to the transmission and reception point identifier.
